(19) United States
(12) Patent Application Publication
(10) Pub. No.: US 2005/0144525 A1
(43) Pub. Date: Jun. 30, 2005

(54) Method to test memories that operate at twice their nominal bandwidth

(76) Inventors: Keerthinarayan Heragu, Richardson, TX (US); Magesh Hariharan, San Diego, CA (US); Theo J. Powell, Dallas, TX (US)

Correspondence Address: TEXAS INSTRUMENTS INCORPORATED, P O BOX 655474, M/S 3999, DALLAS, TX, 75265, US

(21) Appl. No.: 10/729,118

(22) Filed: Dec. 5, 2003

(51) Int. Cl. G06F 11/00

(52) U.S. Cl. 714/30

(57) ABSTRACT

The method for at-speed testing in a memory built-in-self-test (BIST) when the memory accesses happen at twice the clock frequency includes: generating addresses for read/write operations at twice the clock frequency; generating data for write operations at twice the clock frequency; and generating expected outputs for read operations at twice the clock frequency.

### SUMMARY OF THE INVENTION

A method for at-speed testing in a memory built-in-self-test (BIST) when the memory accesses happen at twice the clock frequency includes: generating addresses for read/write operations at twice the clock frequency; generating data for write operations at twice the clock frequency; and generating expected outputs for read operations at twice the clock frequency.

### DETAILED DESCRIPTION OF PREFERRED EMBODIMENT

The present invention is a method which modifies a prior art memory built-in-self-test (BIST) circuit to enable at-speed testing when the memory accesses happen at twice the clock frequency. BIST circuits are well known to those skilled in the art. The changes to the BIST circuitry fall into three categories:
(a) generating addresses for read/write operations at twice the clock rate;
(b) generating data for write operations at twice the clock rate; and
(c) generating expected outputs for read operations at twice the clock rate.

(a) Address Generation

Two read/write addresses are generated by toggling the least significant bit (LSB) of the row address. This ensures that the second read/write operation will access the row that is next to the one that is accessed by the first operation.

(b) Data Generation

As is well known in the art, data is generated in the BIST circuit based on the BIST controller state information and the write address. In the present invention, two sets of data are generated per clock cycle in the modified BIST circuit by using the two write addresses (generated in (a) above) and a registered version of the state information.

(c) Expected Output Generation

As is well known in the art, expected output is generated in the BIST circuit based on the BIST controller state information and the read address. In the present invention, two expected outputs are generated per clock cycle in the modified BIST circuit by using the two read addresses (generated in (a) above) and the state information.

Apart from the above three categories, only minor changes such as inserting the correct number of pipeline stages are necessary. Most of the capabilities of the prior art BIST pattern sequence, in terms of fault detectability, are maintained in the modified BIST pattern sequence, according to the present invention.

While this invention has been described with reference to an illustrative embodiment, this description is not intended to be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

1. A method for at-speed testing in a memory built-in-self-test (BIST) when memory accesses happen at twice a clock frequency comprising:
generating addresses for read/write operations at twice the clock frequency;
generating data for write operations at twice the clock frequency; and
generating expected outputs for read operations at twice the clock frequency.

2. The method of claim 1 wherein the step of generating addresses comprises generating two addresses by toggling the least significant bit of a row address.

3. The method of claim 2 wherein two write addresses are generated each clock cycle.

4. The method of claim 3 wherein the step of generating data comprises generating two sets of data per clock cycle by using the two write addresses and BIST controller state information.

5. The method of claim 2 wherein two read addresses are generated each clock cycle.

6. The method of claim 5 wherein the step of generating expected outputs comprises generating two expected outputs per clock cycle by using the two read addresses and BIST controller state information.
